(19) United States
(12) Patent Application Publication
(10) Pub. No.: US 2013/0007218 A1
(43) Pub. Date: Jan. 3, 2013

(54) Network Assisted Tracker for Better P2P Traffic Management

(75) Inventors: Nilesh Shah, Fremont, CA (US); Shyam Kapadia, Santa Clara, CA (US); Yao Lin, San Jose, CA (US); Chengelpet Ramesh, San Jose, CA (US); Xiaorong Qu, Cupertino, CA (US); Fangping Liu, San Jose, CA (US)

(73) Assignee: Cisco Technology, Inc., San Jose, CA (US)

(21) Appl. No.: 13/171,149

(22) Filed: Jun. 28, 2011

(51) Int. Cl. G06F 15/16; G06F 15/173

(52) U.S. Cl. 709/219; 709/238

(57) ABSTRACT

Embodiments described herein may disclose systems and methods to employ an enhanced tracker in a P2P scenario to increase P2P performance and efficiency. After receiving a request for content the tracker may assist in obtaining as many chunks of the requested content as possible from the plurality of peers on the local network and may obtain any chunks of the requested content not obtained from the plurality of peer on the local network from a randomly selected list of remote peers.

### TECHNICAL FIELD

The present disclosure relates generally to solving issues with peer-to-peer (“P2P”) via implementation of an enhanced tracker module in a network device to better manage P2P traffic in an enterprise setting.

### BACKGROUND

The analysis of current Internet traffic still shows peer-to-peer traffic comprising a substantial share. Peer-to-peer networks may offer inherent advantages in comparison to the traditional client-server architecture where the server workload increases linearly as the number of clients go up. Generally, the increased scale may be handled by deploying more servers or by using alternate solutions like Content-Delivery-Networks (CDNs). Both solutions are expensive and do not make the best use of available resources. P2P treats all network participants as peers so that both their upload and download bandwidth may be efficiently utilized.

However, the problem is that a P2P network is an overlay which has no idea of the physical network topology. There is an inherent limitation in that every peer treats every other peer as equal irrespective of whether it is part of the peer's LAN or located on the other side of the world. So a given peer may download content of interest from another peer which is far away and only reachable through several WAN links when it could have obtained the information from local peers. WAN bandwidth is a valuable resource and should be more efficiently utilized than is done by prior art systems.

### BRIEF DESCRIPTION OF THE DRAWINGS

Many aspects of the disclosure can be better understood with reference to the following drawings. The components in the drawings are not necessarily to scale. Emphasis is instead placed upon clearly illustrating the principles of the present disclosure. Moreover, in the drawings, like references numerals designate corresponding parts through the several figures.

FIG. 1 is a block diagram illustrating an example environment in which certain embodiments of the present disclosure may be implemented.

FIG. 2 is a flow chart of a method for providing embodiments of P2P traffic management.

FIG. 3 is a block diagram illustrating an example environment in which certain embodiments of the present disclosure may be implemented.

FIG. 4 is a block diagram illustrating an example environment in which certain embodiments of the present disclosure may be implemented.

### DETAILED DESCRIPTION OF EXAMPLE EMBODIMENTS

In various embodiments, a method may comprise receiving a request for a content of interest; maintaining a routing information database comprising at least one routing metric for each peer; querying the routing information database to obtain a list of peers that have at least a portion of the content of interest; and returning a list of peers based on the routing metric for each peer.

Other embodiments of the present disclosure may disclose a method comprising receiving a request for a content of interest; obtaining metric information for a plurality of peer devices that have at least a portion of the content of interest; comparing the metric information with a threshold value; classifying each peer device with a value below the threshold value as a local peer device; classifying each peer device with a value above the threshold value as a remote peer device; and receiving the content of interest from a majority of identified local peer devices.

Other embodiments of the present disclosure may disclose a network device comprising: an enhanced tracker; and a torrent file to track content to be pushed from a plurality of servers comprising the number of chunks associated with the content. The network device may further comprise a processor configured to: transmit the IP address of the enhanced tracker to a plurality of peers on a local network; receive a request for content; obtain as many chunks of the requested content as possible from the plurality of peers on the local network; and obtain any chunks of the requested content not obtained from the plurality of peer on the local network from a randomly selected list of remote peers.

Embodiments of the present invention for P2P traffic management may be implemented in hardware, software, firmware, or a combination thereof (collectively or individually also referred to herein as logic). To the extent certain embodiments, or portions thereof, are implemented in software or firmware, executable instructions or code for performing one or more tasks of P2P traffic management are stored in memory or any other suitable computer readable medium and executed by a suitable instruction execution system. In the context of this document, a computer readable medium is an electronic, magnetic, optical, or other physical device or means that can contain or store a computer program for use by or in connection with a computer related system or method.

To the extent embodiments, or portions thereof, are implemented in hardware, the present invention may be implemented with any or a combination of the following technologies: a discrete logic circuit(s) having logic gates for implementing logic functions upon data signals, an application specific integrated circuit (ASIC) having appropriate combinational logic gates, programmable hardware such as a programmable gate array(s) (PGA), a field programmable gate array (FPGA), etc.

In the past few years, BitTorrent has become the protocol of choice for P2P traffic. BitTorrent has addressed some limitations of earlier P2P technologies, but still suffers from the same limitations due to lack of network topology knowledge. With BitTorrent, a given content of interest may be associated with a “torrent” file. The torrent file may contain metadata of the content. The metadata may include the number of chunks that the content needs to be broken into, the hash for each chunk for integrity purposes, and the IP address (or URL) of an entity called the “tracker”. The tracker is a central entity that may keep track of which peers in the network have either complete or partial copies of the content of interest tracked by the torrent file.

When a client peer wants to obtain content of interest, it first needs to obtain the torrent file associated with the content. Subsequently, the torrent file may be loaded into any BitTorrent client of choice which in turn may query the tracker and obtains the IP addresses of the peers from which it starts obtaining chunks of the content in parallel (different chunks from different peers). The client peer may simultaneously download some chunks and upload previously downloaded chunks to other peers who need them (a swarm).

The tracker may usually be an end-host, much like a peer, which has no knowledge of the network topology. Consequently, whenever a client queries the tracker for a list of peers that have the content of interest, it may randomly return a list of “n” peers from the entire set of peers that have the content of interest. The tracker, much like the peers, is network-connectivity agnostic. As such, like other P2P traffic, the peers returned may be located across geographical boundaries (remote peers). Downloading the content from these peers will result in consumption of the WAN bandwidth. Usually, for enterprise networks and more generally for other networks as well, local peers on a LAN are much faster than the remote peers (reachable via WAN). So as a resultant side effect, the download from remote peers takes significantly longer than if the download was focused on local peers.

BitTorrent is currently being used in a variety of real-world applications. One primary example is in a university campus setting. In this setting, the consumers have indicated that P2P traffic utilizes a large amount of the university's WAN resources. This P2P traffic cannot be blocked or filtered by deep-packet inspection due to the level of encryption as well as other privacy related reasons. So the university network administrators are trying to find a way to efficiently control P2P traffic over the WAN link. In the case of large organizations, such as Facebook or Twitter, BitTorrent may be employed to periodically push updates to servers in their data centers located across geographical boundaries. This process may be made more efficient if the P2P traffic may be localized whenever possible as discussed by embodiments described in this specification.

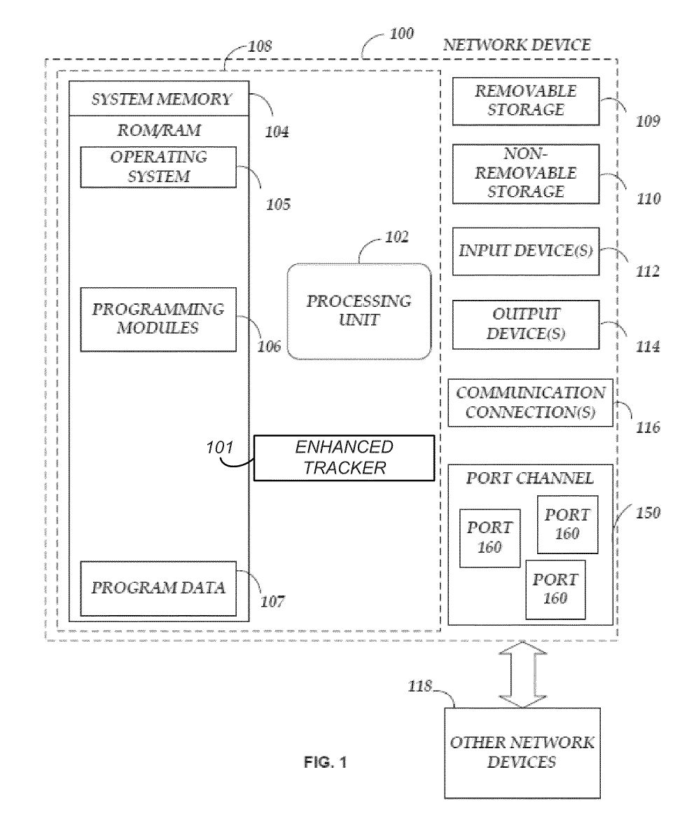

FIG. 1 is a block diagram of a system including network device 100. Consistent with embodiments of P2P traffic management, a tracker 101 may be implemented in network device, such as network device 100 of FIG. 1. In embodiments, network device 100 may be a network switch or a network router. Any suitable combination of hardware, software, or firmware may be used to implement the tracker 101. For example, the tracker 101 may be implemented with network device 100 or any of other network devices 118. The aforementioned system, device, and processors are examples and other systems, devices, and processors may comprise the aforementioned memory storage and processing unit, consistent with embodiments of P2P traffic management. Furthermore, network device 100 may comprise an operating environment as described above.

With reference to FIG. 1, a system consistent with embodiments of the present disclosure of P2P traffic management may include a network device, such as network device 100. In a basic configuration, network device 100 may include at least one processing unit 102 and a system memory 104. Depending on the configuration and type of network device, system memory 104 may comprise, but is not limited to, volatile (e.g., random access memory (RAM)), non-volatile (e.g., read-only memory (ROM)), flash memory, or any combination. System memory 104 may include operating system 105, one or more programming modules 106, and may include program data 107. Operating system 105, for example, may be suitable for controlling network device 100's operation. Furthermore, embodiments of P2P traffic management may be practiced in conjunction with a graphics library, other operating systems, or any other application program and is not limited to any particular application or system. This basic configuration is illustrated in FIG. 1 by those components within a dashed line 108.

Network device 100 may have additional features or functionality. For example, network device 100 may also include additional data storage devices (removable and/or non-removable) such as, for example, magnetic disks, optical disks, or tape. Such additional storage is illustrated in FIG. 1 by a removable storage 109 and a non-removable storage 110. Computer storage media may include volatile and nonvolatile, removable and non-removable media implemented in any method or technology for storage of information, such as computer readable instructions, data structures, program modules, or other data. System memory 104, removable storage 109, and non-removable storage 110 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by network device 100. Any such computer storage media may be part of device 100. Network device 100 may also have input device(s) 112 such as a keyboard, a mouse, a pen, a sound input device, a touch input device, etc. Output device(s) 114 such as a display, speakers, a printer, etc. may also be included. The aforementioned devices are examples and others may be used.

Network device 100 may also contain a communication connection 116 that may allow network device 100 to communicate with other network devices 118, such as over a network in a distributed network environment, for example, an intranet or the Internet. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 104, including operating system 105. While executing on processing unit 102, programming modules 106 may perform processes including, for example, one or more of method 200's stages as described below.

For peer client requests, tracker 101 may be enhanced to return the list of peers on the basis of the routing metric for each peer through the collection of information about peers and responses to peer requests. Today every network device 100 that runs routing protocols may maintain a routing information database (“RIB”). For each route prefix in the RIB, there is a metric maintained by tracker 101 which may indicate the cost to reach a particular prefix. This information may be stored in a sorted table of routing costs. A peer with a given IP address will be associated with some prefix representing the subnet that it is a part of Consequently, network device 100 may already have knowledge about the cost to reach a particular peer. Tracker 101 software module running on network device 100 may query the RIB to obtain this information so that it can sort the peer IP addresses in accordance with the metric. A peer with a low metric value is preferred as it may be likely to be reachable via the LAN and accordingly provide higher bandwidth for peer data exchange especially in an enterprise environment. The top “n” peer IP addresses may be returned for each client request. The IP addresses may be returned in a table sorted by routing cost.

Embodiments in this specification may allow the network administrator to control the number of peers returned for each client request as well as what percentage of these should be considered preferred peers. A preferred peer is one that has a lower routing metric or cost. Note that the routing metrics represent the cost of reaching a particular peer IP address from network device 100 itself However, the peers may be located anywhere across the enterprise network. In order to ensure that the preferred list returned by the tracker is valid for clients, the tracker must be able to distinguish between requests coming from local peers vs. remote peers. A local peer may be defined as one that has a low cost to reach the tracker and vice-versa. A remote peer is one that has a high cost associated with it, for example requiring traversal over a WAN.

There are a large number of routing protocols that are available, namely OSPF, RIP, EIGRP, and many others. Each routing protocol may have a specific formula for calculating the routing metric. Embodiments of this disclosure may normalize the routing metric so that every peer is associated with a value within a predetermined range. For example, a range between 0 and 100 may be employed for metric purposes. Lower values may indicate a low cost, most likely a local peer. Similarly, higher values may correspond to a high cost, most likely a remote peer.

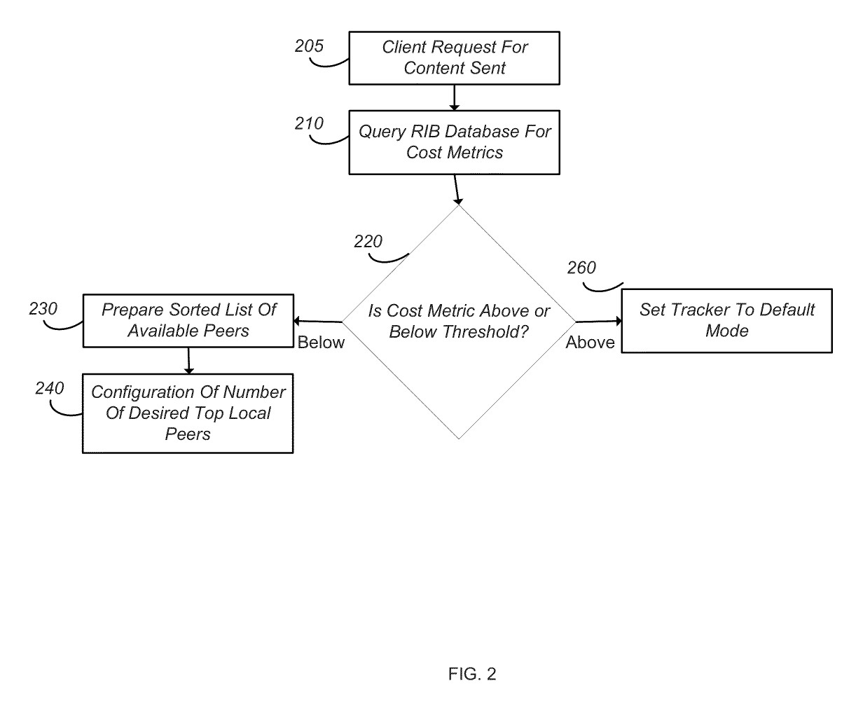

FIG. 2 is a flow chart illustrating embodiments of achieving even load-balanced hash value distribution. Method 200 may initialize at step 205 where a client peer request is sent from a client and received by the tracker. Method 200 may proceed to step 210, where the cost to reach the IP address of the client peer by querying the RIB database. Method 200 may subsequently proceed to step 220, where it may be determined whether or not the determined cost is below a set threshold. The threshold may be user determined or may be based upon determined network conditions. It should be understood that the threshold may be determined in any number of ways suitable for identification of relative cost values.

At step 220, if it is determined that the determined cost is below the set threshold, the client peer is designated as a local client peer and method 200 may proceed to step 230. At step 220, if it is determined that the determined cost is above the set threshold, the client peer is designated as a remote client peer and method 200 may proceed to step 260.

At step 230, for each of the peers that have the requested content of interest for the client peer, a sorted list may be prepared of the peers based on their IP addresses and the corresponding cost associated with them as indicated by the RIB. For example, let (L) is the set of peers that are classified as local peers. Let (R) be the set of peers classified as remote peers. Then the total number of peers may be (N)=(L) U (R). Let “n” be the number of peers returned by tracker X for each client request. |S| may indicate the cardinality of a set S. If n<|L|, then the top n local peers may ne returned from (L). If n>|L|, then |L| local peers are returned and the remaining n−|L| may be chosen at random from remote list (R).

From step 230, method 200 may progress to step 240 where the value of n may be configured by a system administrator. For example, network conditions may indicate that a different “n” number of top local peers would be more advantageous. A common “n” implementation may be 50 top local peers, however, any number may be used as appropriate.

From step 220, if it is determined that the determined cost is above the set threshold, the client peer is designated as a remote client peer and method 200 may proceed to step 260. At step 260, tracker X is set to a default mode as described in conjunction with current BitTorrent systems. Resultantly, the tracker may return a random list of n peer IP addresses to the client peer.

Some embodiments described herein may make the information about routing metric from the RIB available to an external tracker. For example, an external tracker may be running on a Unified Computing System (“UCS box”). The external tracker may serve to call APIs which may allow the export of information from the RIB to application services. In that sense, the enhanced tracker may run on the UCS box as opposing to a router or switch. The enhanced tracker would still maintain the same functionality as if it were running on any network device.

A network administrator may be responsible for hosting tracker 101 by making tracker 101 part of a Virtual Private Network (“VPN”). As such, P2P traffic may be localized to that VPN. In other words, peers will need to join the VPN to contact tracker 101. This may ensure that P2P traffic does not interfere with the other traffic flowing through the enterprise network.

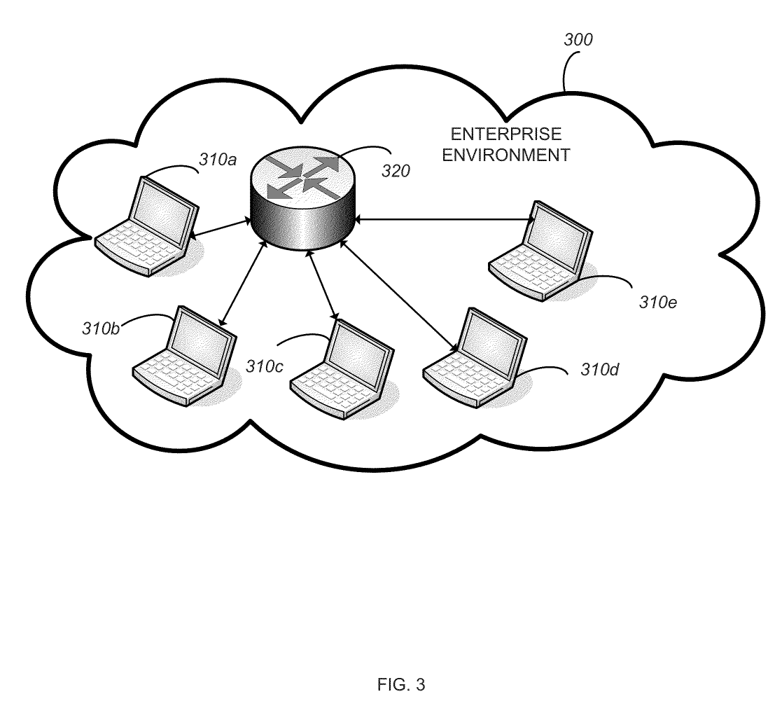

FIG. 3 illustrates operating environments for embodiments described in the specification. Enterprise environment 300 may be an enterprise environment like Facebook and Twitter, where BitTorrent is being employed to push periodic updates to all servers 310a-d. An enhanced tracker 320, is described in embodiments of the specification may be enabled in the network. A torrent file 330 may track the contents to be pushed from servers 310a-d. Torrent file 330 may point to the IP address of enhanced tracker 320. Torrent file 330 may also contain the number of chunks associated with the desired content and the overall size of the file. As such, the embodiments described in the specification may ensure that servers 310a-d, which may be located within data centers at a single location, will choose other local servers 310a-d to receive the periodic updates as opposed to traversing WAN boundaries as in prior art systems. In some embodiments, this deployment model may be used in a setting where thousands of computers may reside within the local geographical area.

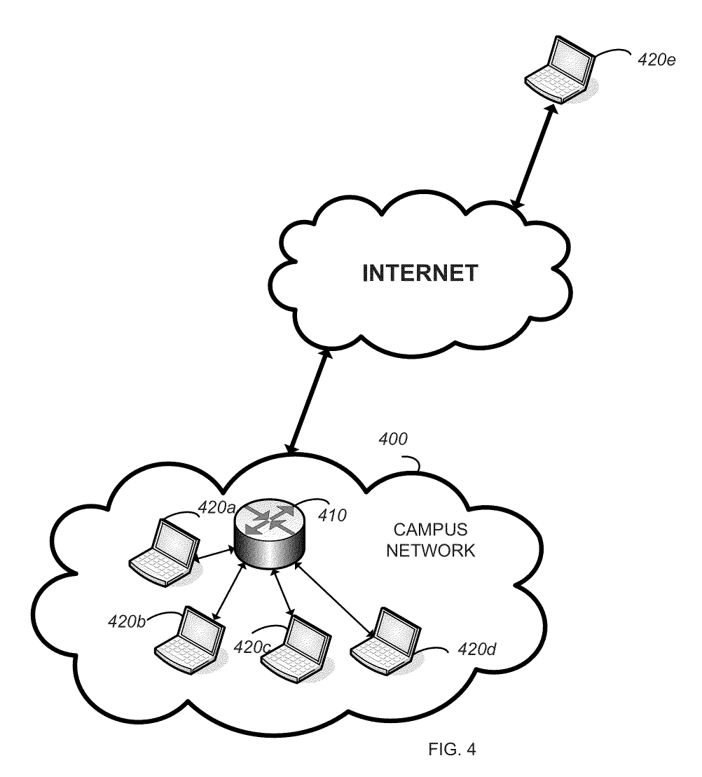

FIG. 4 illustrates operating environments for embodiments described in the specification. As discussed above, P2P is a major bandwidth consumer for university campus networks, such as campus network 400. A campus network administrator may enable the enhanced tracker 410 in campus network 400. The IP address of enhanced tracker 410 may be known to the student end-users 420a-d (“peers”) across campus network 400. In some embodiments, the host name of tracker (i.e., “univ-x-tracker”) may be made known instead of the IP address. When student end-users 420 a-d have access to campus network 400, either due to physically being on campus, or through VPN access (like student end-user 420e), they will have access to enhanced tracker 410 to receive better P2P performance.

Enhanced tracker 410 must be added to a list of trackers in the torrent files employed for content exchange. This is beneficial to campus network 400 as the WAN resources may be utilized to fetch content from outside of campus network 400 only if the content is not locally available on the peers 420a-e located in campus network 400. This allows the student end-users 420 a-e to get better P2P performance, as well as better utilizing the WAN resources of the university. Embodiments described in the present specification are more effective then currently employed patchwork solutions such as traffic shaping and traffic policing.

In embodiments of this disclosure, the network device running the tracker should not also store available content of interest. This ensures that the messaging between the tracker and peers can be low-rate as no content exchange is occurring. Additionally, mechanisms such as Control-plane policing (CoPP), rate-limiters, etc. may be employed to ensure that the network device is not overwhelmed and that denials of service may be avoided.

Embodiments described in this disclosure may be incrementally deployed. Initially, if P2P traffic is found to be large in a certain geographical area, the enhanced tracker may be deployed at the distribution layer of that geographical area (campus) to provide better services to the peers within that area. As concentration of remote peers grows, the network administrator can intelligently deploy a tracker within a remote geographical area (remote campus) to allow those peers to also gain similar benefits while making sure that P2P traffic efficiently utilizes WAN resources.

Embodiments described in this disclosure may require that the tracker is registered with Virtual Routing and Forwarding (“VRF”). VRF is a technology that allows multiple instances of a routing table to exist on the same network device at the same time. Since each VRF is independent, the same IP subnet can exist in 2 different VRFs. For ample, peers would only be able to communicate with the tracker after joining the VRF. As such, P2P traffic may be restricted to a known VRF.

In some embodiments of this disclosure, trackers may be deployed at multiple network devices, The multiple trackers may exchange published information with one another. The multiple trackers may keep track of the local peers. The (content, peel, locality) information may then be shared amongst the, multiple trackers. For each client request, any of the trackers may independently decide whether or not to return an enhanced or random list of available peers.

Embodiments of the present disclosure, for example, are described above with reference to block diagrams and/or operational illustrations of methods, systems, and computer program products according to embodiments of this disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and are the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

At least the following is claimed:

1. A method comprising:
receiving a request for a content of interest;
maintaining a peer routing information database comprising at least one routing metric for each peer;
querying the maintained peer routing information database to obtain a list of peers that have at least a portion of the content of interest; and
returning a list of peers based on the routing metric for each peer.

2. The method of claim 1, wherein the returned list of peers is a table sorted by the routing metric.

3. The method of claim 2, wherein the routing information database associates each peer with a prefix representing the subnet that the peer is a member of

4. The method of claim 1, wherein the list of peers is limited to a predetermined number of top peer addresses.

5. The method of claim 2, wherein the routing metric is a cost associated with delivering the content of interest.

6. The method of claim 4, wherein the predetermined number of top peer addresses is determined by a network administrator.

7. The method of claim 6, further comprising:
classifying a subset of top peer addresses as local peers and classifying the remainder as remote peers.

8. A method comprising:
receiving a request for a content of interest;
obtaining metric information for a plurality of peer devices that have at least a portion of the content of interest;
comparing the metric information with a threshold value;
classifying each peer device with a value below the threshold value as a local peer device;
classifying each peer device with a value above the threshold value as a remote peer device; and
receiving the content of interest from a majority of identified local peer devices.

9. The method of claim 8, wherein the routing metric is a normalized value within a predetermined range.

10. The method of claim 8, wherein the majority of identified local peer devices is limited by a predetermined limit.

11. The method of claim 10, wherein the remainder of required peer devices to effectuate download of the content of interest are randomly selected from the identified remote peer devices.

12. The method of claim 8, further comprising:
sending the metric information to one or more external trackers.

13. The method of claim 8, further comprising:
control-plane policing to avoid an overload of requests.

14. The method of claim 8, wherein the metric information is received from a routing information database.

15. A network device comprising:
an enhanced tracker;
a torrent file to track content to be pushed from a plurality of servers comprising the number of chunks associated with the content;
a processor configured to:
receive a request for content;
obtain as many chunks of the requested content as possible from the plurality of peers on the local network; and
obtain any chunks of the requested content not obtained from the plurality of peer on the local network from a randomly selected list of remote peers.

16. The system of claim 15, wherein the network device is a network switch.

17. The system of claim 15, wherein the enhanced tracker shares cost information with a plurality of other enhanced trackers.

18. The system of claim 15, wherein the enhanced tracker is part of a virtual private network.

19. The system of claim 17, wherein shared information includes at least an identifier of the content, identification of the peer device, and the locality of the peer device.

20. The system of claim 15, wherein the local network comprises a university enterprise network.
